(19) United States
(12) Patent Application Publication
(10) Pub. No.: US 2007/0268538 A1
(43) Pub. Date: Nov. 22, 2007

(54) HOLOGRAPHIC RECONSTRUCTION APPARATUS, HOLOGRAPHIC RECORDING/RECONSTRUCTION APPARATUS, AND HOLOGRAPHIC RECONSTRUCTION METHOD

(75) Inventors: Koji Ishioka, Kanagawa (JP); Mikio Sugiki, Kanagawa (JP); Atsushi Fukumoto, Kanagawa (JP); Masaaki Hara, Tokyo (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/749,571

(22) Filed: May 16, 2007

(30) Foreign Application Priority Data
May 17, 2006 (JP) 2006-137156

(51) Int. Cl. G03H 1/10

(52) U.S. Cl. 359/10

(57) ABSTRACT

A holographic reconstruction apparatus is provided. The holographic reconstruction apparatus reconstructs recording data recorded on a holographic recording medium from diffracted light generated by emitting reference light from a laser light source to the holographic recording medium. The apparatus includes a spatial light modulator applying spatial modulation on a light beam to form a predetermined reference light pattern for generating the reference light; an array optical detector detecting the luminance of a reconstructed image generated by the diffracted light and generating reconstruction data based on the luminance; and a controller controlling the spatial light modulator to form, as the predetermined reference light pattern, a first reference light pattern and a second reference light pattern, which is a reversal of the first reference light pattern, and reconstructing the recording data on the basis of after-calculation reconstruction data according to a difference between first and second reconstruction data based on the first and second reference light patterns.

### CROSS REFERENCES TO RELATED APPLICATIONS

The present application claims priority to Japanese Patent Application JP 2006-137 filed in the Japanese Patent Office on May 17, 2006, the entire contents of which are incorporated herein by reference.

### BACKGROUND

The present application relates to holographic reconstruction apparatuses, holographic recording/reconstruction apparatuses, and holographic reconstruction methods.

Holographic recording apparatuses and methods for recording data using holograms have been proposed. That is, signal light modulated by information to be recorded (recording data) and reference light is generated and emitted from one laser light source to a holographic recording medium. Accordingly, the signal light and the reference light interfere with each other to generate an interference pattern on the holographic recording medium. Depending on the shape of the interference pattern, a diffraction grating (hologram) is formed in the holographic recording medium, thereby recording the recording data. In this case, a spatial light modulator is used to generate the signal light and the reference light. In the spatial light modulator, in units of very small areas (pixel) each having a predetermined area, transmissive areas (transmissive pixels) allowing passage of a light beam from the laser light source and light-blocking areas (light-blocking pixels) blocking a light beam from the laser light source are arranged in a predetermined pattern having a predetermined set thereof. The predetermined pattern includes a signal light pattern in which a set of transmissive pixels and light-blocking pixels is changed and distributed according to the recording data and a reference light pattern in which transmissive pixels and light-blocking pixels are associated and distributed in a predetermined manner.

Holographic reconstruction apparatuses and methods for reconstructing the recording data from the diffraction grating (hologram) recorded in this manner are also proposed. That is, reconstruction light (diffracted light) is generated by emitting reference light to the diffraction grating (hologram) formed on an already-recorded recording medium. The reconstruction light is emitted to very small areas (pixels) arranged in two dimensions on an array optical detector, each of the pixels having a predetermined area, and a light sensor included in each of the pixels generates a light-reception signal (reconstruction data) on the basis of the reconstruction light. It is then determined whether a value of the light-reception signal (reconstruction data) exceeds a threshold, and a detected binary signal is processed and decoded, thereby reconstructing the recording data.

In such recording/reconstruction (recording and/or reconstruction) techniques, two recording/reconstruction methods are proposed in regard to the manner in which signal light and reference light is generated. These two methods are a two-beam interference recording/reconstruction method (hereinafter abbreviated as a “two-beam method”) of providing completely separate optical paths for signal light and reference light and a coaxial recording/reconstruction method (hereinafter abbreviated as a “coaxial method”) of providing optical paths for signal light and reference light on the same axis so that the signal light and the reference light share one optical path (for example, see Nikkei Electronics, Jan. 17, 2005: 106-114.) In the coaxial method, a signal light pattern and a reference light pattern are located in different areas on the same plane. In the two-beam method, a signal light pattern and a reference light pattern are located on different planes (for example, see Nikkei Electronics, Jan. 17, 2005: 106-114.)

Techniques based on analytical study of the principle of holographic recording are also known (for example, see Tsutomu Shimura, et al. “Analysis of a Collinear Holographic Storage System: Introduction of Pixel Spread Function.” Optics Letters Vol. 31, No. 9 (May 1, 2006): 1208).

In the above-described holographic recording/reconstruction techniques, it is preferable that a diffraction grating (hologram) be formed in a holographic recording medium by interference of signal light and reference light. However, light beams passing through the pixels interfere with one another in an undesired manner. For example, light beams passing through pixels constituting a signal light pattern interfere with one another, or light beams passing through pixels constituting a reference light pattern interfere with one another. Such undesired interference also forms a diffraction grating in the holographic recording medium. Reconstruction light components coming from a hologram formed by such undesired mutual interference of optical beams passing through these pixels act as noise and cause degradation of quality of a reconstructed signal. These noise components could not have been removed by known techniques.

### SUMMARY

It is desirable to provide a holographic reconstruction apparatus, a holographic recording/reconstruction apparatus, and a holographic reconstruction method of removing noise components obtained as light diffracted from a hologram formed by undesired mutual interference of optical beams passing through pixels, thereby obtaining a reconstructed signal of excellent quality.

According to an embodiment, there is provided a holographic reconstruction apparatus for reconstructing recording data recorded on a holographic recording medium from diffracted light generated by emitting reference light from a laser light source to the holographic recording medium. The holographic reconstruction apparatus includes the following elements: a spatial light modulator configured to apply spatial modulation on a light beam emitted from the laser light source to form a predetermined reference light pattern for generating the reference light; an array optical detector configured to detect the luminance of a reconstructed image generated by the diffracted light and generate reconstruction data on the basis of the detected luminance; and a controller configured to control the spatial light modulator to form, as the predetermined reference light pattern, a first reference light pattern and a second reference light pattern, the second reference light pattern being a reversal pattern of the first reference light pattern, and to reconstruct the recording data on the basis of a value of after-calculation reconstruction data according to a difference between a value of first reconstruction data based on the first reference light pattern and a value of second reconstruction data based on the second reference light pattern, the first and second reconstruction data coming from the array optical detector.

The holographic reconstruction apparatus includes the spatial light modulator, the array optical detector, and the controller. The spatial light modulator forms a predetermined reference light pattern for generating reference light in units of pixels. The array optical detector detects the luminance of a reconstructed image and generates reconstruction data on the basis of the detected luminance. The controller controls the spatial light modulator to form, as the predetermined reference light pattern, a first reference light pattern and a second reference light pattern, which is a reversal pattern of the first reference light pattern. The recording data is reconstructed on the basis of a value of after-calculation reconstruction data according to a difference between a value of first reconstruction data based on the first reference light pattern and a value of second reconstruction data based on the second reference light pattern, the first and second reconstruction data coming from the array optical detector.

According to another embodiment, there is provided a holographic recording/reconstruction apparatus for recording, as a hologram, an interference pattern generated by emitting reference light and signal light from a laser light source onto a holographic recording medium and reconstructing recording data recorded on the holographic recording medium from diffracted light obtained by emitting the reference light to the holographic recording medium in which the hologram is recorded. The holographic recording/reconstruction apparatus includes the following elements: a spatial light modulator configured to apply spatial modulation on a light beam emitted from the laser light source to form a predetermined reference light pattern for generating the reference light and a signal light pattern according to the recording data on one and the same plane; an array optical detector configured to detect the luminance of a reconstructed image generated by the diffracted light and generate reconstruction data on the basis of the detected luminance; and a controller configured to control the spatial light modulator to form, as the predetermined reference light pattern, a first reference light pattern and a second reference light pattern, the second reference light pattern being a reversal pattern of the first reference light pattern, and to reconstruct the recording data on the basis of after-calculation reconstruction data, which is a difference between first reconstruction data based on the first reference light pattern and second reconstruction data based on the second reference light pattern, the first and second reconstruction data coming from the array optical detector.

In the holographic recording/reconstruction apparatus, the spatial light modulator applies spatial modulation on light beams emitted from the laser light source to form a predetermined reference light pattern for generating reference light and a signal light pattern according to the recording data on one and the same plane. The array optical detector detects the luminance of a reconstructed image generated by diffracted light and generates reconstruction data on the basis of the detected luminance. The controller controls the spatial light modulator to form, as the predetermined reference light pattern, a first reference light pattern and a second reference light pattern, which is a reversal pattern of the first reference light pattern. The recording data is reconstructed on the basis of a value of after-calculation reconstruction data according to a difference between a value of first reconstruction data based on the first reference light pattern and a value of second reconstruction data based on the second reference light pattern, the first and second reconstruction data coming from the array optical detector.

According to yet another embodiment, there is provided a holographic reconstruction method of reconstructing recording data recorded on a holographic recording medium from diffracted light generated by emitting reference light from a laser light source to the holographic recording medium. The holographic reconstruction method includes the steps of: applying spatial modulation on a light beam emitted from the laser light source to generate first reference light; applying spatial modulation on the light beam emitted from the laser light source to generate second reference light, the second reference light being reversal reference light of the first reference light; detecting first reconstruction data from diffracted light obtained by emitting the first reference light; detecting second reconstruction data from diffracted light obtained by emitting the second reference light; and reconstructing the recording data on the basis of a value of after-calculation reconstruction data according to a difference between a value of the first reconstruction data and a value of the second reconstruction data.

In the holographic reconstruction method, spatial modulation is applied on a light beam emitted from the laser light source to generate first reference light, and spatial modulation is applied on a light beam emitted from the laser light source to generate second reference light. First reconstruction data is detected from diffracted light based on the first reference light, and second reconstruction data is detected from diffracted light based on the second reference light. The recording data is reconstructed on the basis of a value of after-calculation reconstruction data according to a difference between a value of the first reconstruction data and a value of the second reconstruction data.

According to the embodiments, a holographic reconstruction apparatus, a holographic recording/reconstruction apparatus, and a holographic reconstruction method that remove noise components obtained as light diffracted from a hologram formed by undesired mutual interference of light beams passing through pixels and that achieve a reconstructed signal of excellent quality are provided.

Additional features and advantages are described herein, and are apparent from, the following Detailed Description and the figures.

### BRIEF DESCRIPTION OF THE FIGURES

FIG. 1 is a conceptual diagram of a holographic recording/reconstruction apparatus using a coaxial method;

FIG. 2 is a diagram showing the principle of holographic recording;

FIGS. 3A to 3C are diagrams showing an exemplary reference light pattern;

FIGS. 4A to 4C are diagrams showing a reconstructed image near the center, which is formed by diffracted light;

FIGS. 5A to 5C are diagrams showing a reconstructed image near the outer periphery, which is formed by diffracted light;

FIGS. 6A and 6B are diagrams showing another exemplary reference light pattern;

FIGS. 7A to 7C are diagrams showing a reconstructed image near the center, which is formed by diffracted light;

FIGS. 8A to 8C are diagrams showing a reconstructed image near the outer periphery, which is formed by diffracted light;

FIGS. 9A and 9B are diagrams showing yet another exemplary reference light pattern;

FIGS. 10A to 10C are diagrams showing a reconstructed image near the center, which is formed by diffracted light;

FIGS. 11A to 11C are diagrams showing a reconstructed image near the outer periphery, which is formed by diffracted light; and

FIG. 12 is a conceptual diagram of a holographic recording/reconstruction apparatus using a two-beam method.

### DETAILED DESCRIPTION

A holographic reconstruction apparatus according to an embodiment obtains, when reconstructing a recorded data signal (hereinafter referred to as “recording data”) from reconstruction light, a reconstructed image formed by a light-receiving element using reconstruction light generated by a reference light pattern (first reference light pattern) used in recording the recording data (hereinafter referred to as “at the time of recording”) and a reconstructed image formed on a surface of the light-receiving element of an array optical detector using reconstruction light generated by a reference light pattern (second reference light pattern), which is a reversal pattern of the reference light pattern used at the time of recording, and calculates the difference between values of pieces of reconstruction data (first reconstruction data and second reconstruction data) obtained as electric signals according to the reconstructed images, thereby reducing degenerate noise components included in the reconstructed images. Accordingly, unlike the related art in which the recording data is reconstructed using only the first reconstruction data as the reconstruction data, according to the embodiment, the recording data is reconstructed using the difference between the values of the first reconstruction data and the second reconstruction data as the reconstruction data, thereby improving the reconstruction quality.

The relationship between the reference light pattern used at the time of recording and the reversal pattern corresponds to the relationship between two types of patterns in which whether each of pixels arranged at the same positions on a two-dimensional plane allows passage of light or not (that is, blocks light) is reversed. That is, in the case that one reference light pattern is specified, when one pixel of the reference light pattern is a transmissive pixel, the pixel at the same position of a corresponding reversal pattern is a light-blocking pixel. Reference light passing through such a reversal pattern is referred to as “reversal reference light” in the following description. A degenerate noise component is a component of a reconstructed signal generated by reconstruction light diffracted from a hologram formed by undesired mutual interference of light beams.

A holographic recording/reconstruction apparatus according to an embodiment is a so-called coaxial holographic recording/reconstruction apparatus. A spatial light modulator applies spatial modulation on a light beam emitted from a laser light source to form a predetermined reference light pattern for generating reference light and a signal light pattern according to the recording data on the same plane. As has been described above, the method used by the holographic recording/reconstruction apparatus having the function of removing degenerate noise at the time of reconstruction is not limited to a coaxial method, and may be a two-beam method. However, the coaxial method has better recording/reconstruction quality.

A brief description of a holographic recording/reconstruction apparatus including a holographic recording apparatus and a holographic reconstruction apparatus according to an embodiment will now be given, which is followed by a brief description of the principle of holographic recording/reconstruction according to the embodiment and a description of specific recording and reconstruction processes.

Description of Holographic Recording/Reconstruction Apparatus

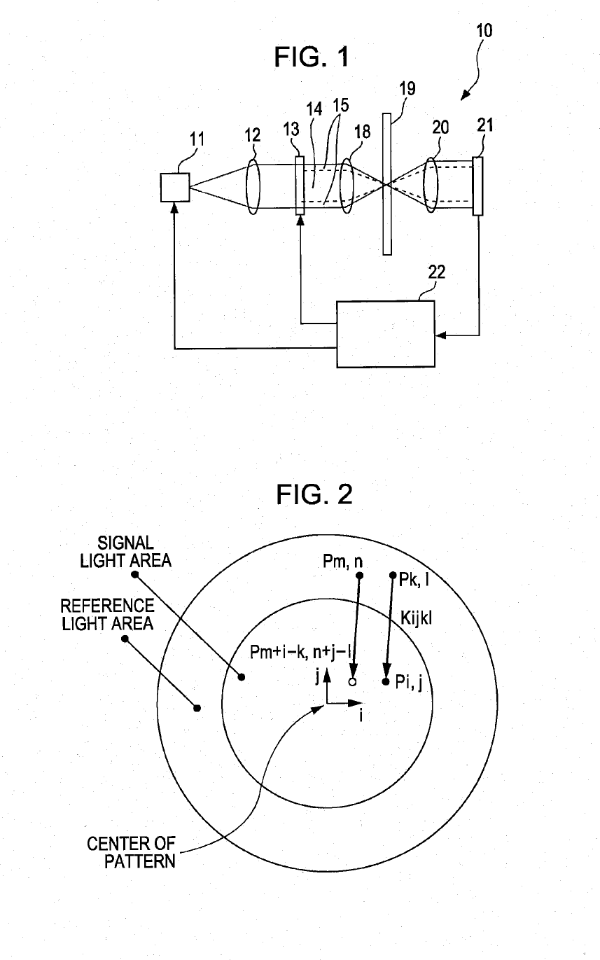

Referring to FIG. 1, a brief description of a holographic recording/reconstruction apparatus 10 will now be given. FIG. 1 shows a coaxial holographic recording/reconstruction apparatus. The principle of recording will now be described. A laser light source 11 emits a light beam. The light beam passes through a collimating lens 12 and enters a spatial light modulator 13. The spatial light modulator 13 has elements configured to control whether to allow passage of or block the light beam in units of spatially-separated very small areas (pixels). The spatial light modulator 13 is divided into two areas: a signal light area in which a signal light pattern is formed; and a reference light area in which a reference light pattern is formed. The intensity of signal light 14 passing through the signal light area and the intensity of reference light 15 passing through the reference light area are modulated and collected by a condensing lens 18 into a holographic recording medium 19, whereby the signal light 14 and the reference light 15 interfere with each other to form an interference pattern, thereby forming a hologram according to the shape of the interference pattern in a recording layer within the holographic recording medium 19.

The above-described process is a coaxial holographic signal recording process. This recording process is under control of a controller 22, which are described in detail later. Regarding the above-mentioned signal light pattern and reference light pattern, the spatial light modulator 13 includes, for example, liquid crystal so that whether each of the pixels belonging to the signal light pattern and the reference light pattern allows passage of or blocks light can be easily controlled by an electric signal from the controller 22.

Next, a coaxial reconstruction process will now be described. A light beam emitted from the laser light source 11 passes through the collimating lens 12 and enters the spatial light modulator 13. To reconstruct data, all the pixels in the signal light area act as light-blocking pixels, thereby blocking the light beam in the area of the signal light 14 and reducing the light intensity to zero. From the reference light area in which the same reference light pattern as that used at the time of recording is formed, only the reference light 15 is obtained, on which spatial modulation has been applied in the same manner as in the time of recording. The reference light 15 passes through the condensing lens 18 and is focused on the hologram in the holographic recording medium 19. By emitting the reference light 15, light diffracted from the hologram in the holographic recording medium 19 passes with a light intensity pattern through a condensing lens 20, and an image is formed on an imaging surface of an array optical detector 21. An image pickup device, such as a charge-coupled device (CCD) or a complementary metal-oxide semiconductor (CMOS), may be used as the array optical detector 21. The imaging surface of the image pickup device has an array of spatially-divided very small areas (pixels). This reconstruction process is under control of the controller 22, which is described in detail later. The light intensity at each of the two-dimensional pixels of the array optical detector 21 is obtained as one-dimensional time-series reconstruction data by the controller 22.

Principle of Holographic Recording/Reconstruction

The principle of holographic recording of the holographic recording/reconstruction apparatus 10 will now be described in more detail with reference to FIG. 2. FIG. 2 schematically shows a surface of the spatial light modulator 13. An inner concentric circle indicates the signal light area, and an outer concentric circle indicates the reference light area. Each of the two-dimensionally-separated signal light pixels in the signal light area and the reference light pixels in the reference light area of the spatial light modulator 13 are given two-dimensional coordinates in the following description. A signal light pixel (i, j) at the coordinates (i, j) and a reference light pixel (k, l) at the coordinates (k, l) form a grating vector Kᵢⱼₖₗ or a diffraction grating recorded on a holographic recording medium, which is expressed as:

Kᵢⱼₖₗ=Pᵢⱼ−Pₖₗ (1)

Each of the two-dimensionally-separated pixels of the array optical detector 21 are similarly given two-dimensional coordinates in the following description. In the case that reference light coming from a reference light pixel (m, n) in the vicinity of the reference light pixel (k, l) is emitted to the grating vector Kᵢⱼₖₗ expressed as equation (1), a reconstructed image emitted as diffracted light is diffracted to a pixel P_{m+i-k, n+j-l}, which is a pixel of the array optical detector 21. In this case, a black mismatch ΔP_{z} and a diffraction efficiency η are expressed as:

$$\begin{matrix}Δ {P}_{z} = ( {P}_{{mn}_{z}} \pm {K}_{{ijkl}_{z}} ) - \sqrt{\begin{matrix}{P}^{2} - {P}_{( m + j - k ) , {( n + j - l )}_{x}}^{2} - \\ {P}_{( m + j - k ) , {( n + j - l )}_{y}}^{2}\end{matrix}} & ( 2 ) \\ η ∝ sin {c}^{2} [ L Δ {P}_{z} / 2 π ] & ( 3 )\end{matrix}$$

where L is the thickness of the recording layer of the holographic recording medium.

In the coaxial holographic recording/reconstruction, for each of the pixels of the array optical detector 21 on which a reconstructed image is formed, the total number of light components diffracted from all the neighboring pixels, including diffracted light components from the neighboring pixels expressed as equation (2) and expression (3), is reconstructed as noise components together with the original reconstructed image. These noise components constitute degenerate noise. The degenerate noise causes degradation of quality of a recorded/reconstructed signal.

Degenerate noise included in a reconstructed image detected in the case that reference light from a reference light pattern at the time of recording is used has substantially the same components as those of degenerate noise included in a reconstructed image detected in the case that reference light from a corresponding reversal pattern is used. The reconstructed image based on the reference light obtained using the reversal pattern contains no components generated by signal light used at the time of recording. The principle of holographic reconstruction according to the embodiment focuses on the above two points and calculates the difference between the two images, thereby reducing the degenerate noise included in the reconstructed image detected using the reconstruction light obtained from the same reference light pattern as that used at the time of recording.

Result of Numerical Analysis

On the basis of equations (1) and (2) and expression (3), the result of reducing the degenerate noise is evaluated using a numerical analysis (simulation).

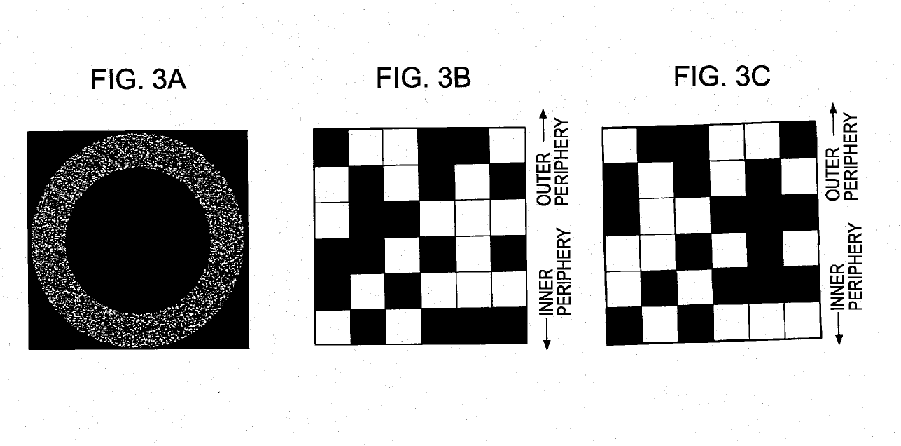

FIG. 3A and FIG. 3B show an exemplary reference light pattern displayed in the reference light area of the spatial light modulator 13. FIG. 3A shows the entire reference light pattern, and FIG. 3B shows an enlarged portion of the reference light pattern such that each of the pixels forming the reference light pattern can be seen. The reference light pattern is provided in a ring shape inside one of two concentric circles having a larger diameter and outside the other circle having a smaller diameter. The reference light pattern is segmented into pixels, as shown in FIG. 3B. Whether each of the pixels included in the pattern allows passage of or blocks light is random. That is, transmissive pixels allowing passage of a light beam and light-blocking pixels blocking a light beam are arranged at random on a two-dimensional plane. Such a reference light pattern is referred to as a random pattern. FIG. 3C shows a reversal pattern of the pattern shown in FIG. 3B. FIG. 3B and FIG. 3C show the same enlarged portion. A comparison between FIG. 3B and FIG. 3C shows that the distributions of transmissive pixels and light-blocking pixels are reversed at the same pixel positions. The advantage of reducing the degenerate noise in using such a random pattern is described below.

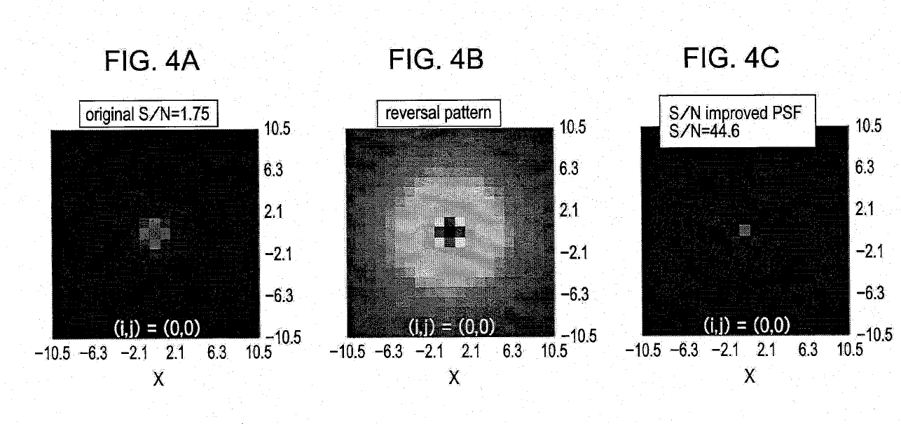

FIG. 4A shows a reconstructed image formed by diffracted light on the imaging surface of the array optical detector 21 in the case that, using the random pattern shown in FIGS. 3A and 3B as a reference light pattern, only a signal light pixel (0, 0), that is, a pixel located at the center of the concentric circles serving as the center of the signal light area, is made to allow passage of a light beam to form a hologram in a holographic recording medium, and reference light from the same random pattern as the reference light pattern used at the time of recording is emitted to the hologram. A dark portion is a portion where the light intensity is high (luminance is high). The center with the highest light intensity is the position at which a desired reconstructed signal is generated. That is, it is ideally preferred that an image be formed by diffracted light only at the pixel of the array optical detector 21 at a position corresponding to the signal light pixel (0, 0). However, due to components of light diffracted from a hologram formed by undesired mutual interference, reconstructed images distributed with continuous light intensities are generated in the vicinity of the above-described center with the highest light intensity. These are degenerate noise components.

FIG. 4B shows a reconstructed image formed by diffracted light on the imaging surface of the array optical detector 21 in the case that, using a reversal pattern of the random pattern used at the time of recording, in which transmissive pixels and light-blocking pixels at the same positions on the two-dimensional plane are reversed, reference light from the reversal pattern is emitted to the same hologram.

FIG. 4C shows the result of calculating the difference (value of after-calculation reconstruction data ΔDᵢ) between a value of reconstruction data D₁ᵢ, which is a reconstructed signal based on the reference light pattern on the imaging surface of the array optical detector 21, and a value of reversal reconstruction data D₂ᵢ, which is a reconstructed signal based on the reversal pattern. In the holographic recording/reconstruction apparatus 10, each of the reconstruction data D₁ᵢ and the reversal reconstruction data D₂ᵢ is analog information whose level changes according to the luminance of the corresponding reconstructed image. Thus, the reconstruction data D₁ᵢ and the reversal reconstruction data D₂ᵢ are transferred into the controller 22 performing digital processing using an analog-to-digital (A/D) converter (not shown), and the controller 22 performs subtraction between the two pieces of data. The after-calculation reconstruction data ΔDᵢ is a binary signal, that is, “1” or “0”, on the basis of a threshold. Thereafter, the controller 22 performs processing, such as error correction or the like, in units of blocks, where one block includes a predetermined number of pieces of the binary data.

As is clear from FIG. 4C, as a result of such a calculation, substantially only a desired reconstructed signal component is generated. As a result of calculating this difference, the signal-to-noise (S/N) ratio of the reconstructed signal is changed from 1.75 (before the calculation) to 44.6 (after the calculation). This shows a significant improvement in the signal quality. The level of the signal S is a root-mean-square (RMS) value of the light intensity at a pixel of the array optical detector 21 at which the luminance is the highest. The level of the noise N is an RMS value of the light intensity at pixels of the array optical detector 21 other than the pixel at which the luminance is the highest. More specifically, for example, in the case that “1” is associated with the case in which the luminance is higher than the threshold, as is clear from FIG. 4C, an interval (amplitude margin) between the threshold and the center with the highest light intensity becomes larger than that before the calculation. Even in the case of large noise, only the center with the highest light intensity is determined as “1” with fewer errors. In the above description, the area of one pixel of the signal light pattern corresponds to the area of one pixel of the array optical detector 21 in a one-to-one relationship.

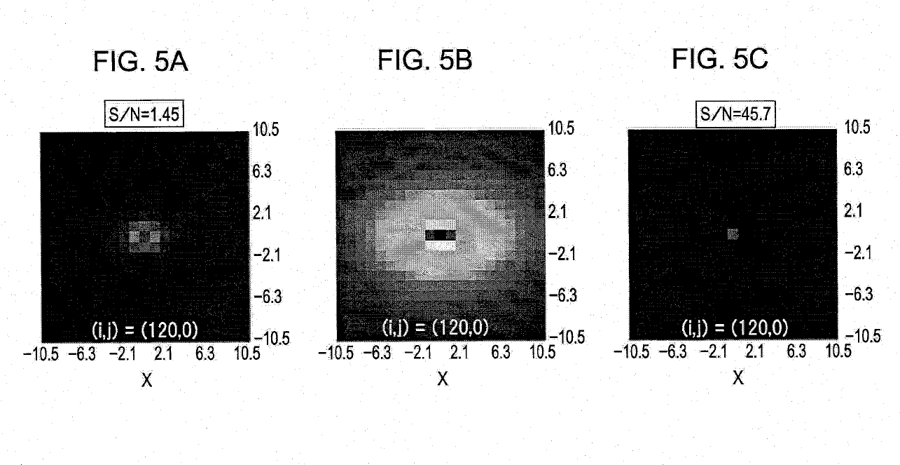

The above description concerns the result of removing the noise at the signal light pixel (0, 0), which is one pixel at the center of the signal area. Similar processing is also applied on a signal light pixel (120, 0), which is a pixel placed on the outer periphery of the signal area, and the processing result is shown in FIGS. 5A to 5C.

FIG. 5A shows a reconstructed image formed by diffracted light on the imaging surface of the array optical detector 21 in the case that, using the random pattern shown in FIGS. 3A and 3B as a reference light pattern, only the signal light pixel (120, 0) is made to allow passage of a light beam to form a hologram in a holographic recording medium, and reference light from the same random pattern used at the time of recording is emitted to the hologram.

FIG. 5B shows a reconstructed image formed by diffracted light on the imaging surface of the array optical detector 21 in the case that, using a reversal pattern of the random pattern used at the time of recording, reversal reference light is emitted to the same hologram.

FIG. 5C shows the result of calculating the difference (value of after-calculation reconstruction data ΔDᵢ) between a value of reconstruction data D₁ᵢ, which is a reconstructed signal based on the reference light pattern on the imaging surface of the array optical detector 21, and a value of reversal reconstruction data D₂ᵢ, which is a reconstructed signal based on the reversal pattern. Also in this case, as is clear from FIG. 5C, the S/N ratio of the reconstructed signal is improved from 1.45 (before the calculation) to 45.7 (after the calculation).

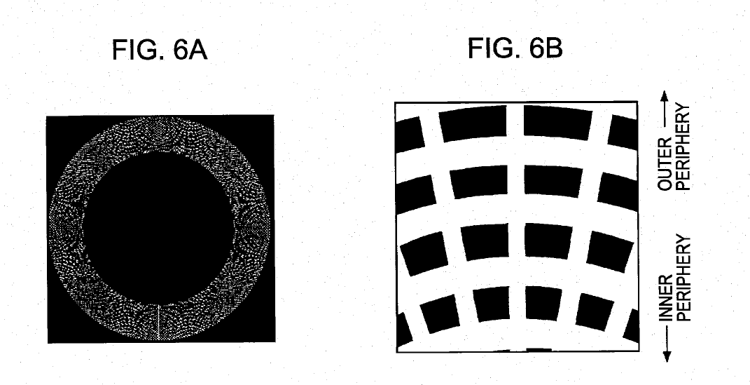

Next, the result of the case in which, instead of the above-described random pattern, a complex pattern of radial lines and concentric circles shown in FIGS. 6A and 6B is used as a reference light pattern is described now. FIG. 6A shows the entire pattern, and FIG. 6B shows an enlarged portion of the pattern. In the complex pattern of radial lines and concentric circles, the radial lines are adjacent with one another at predetermined angles and extend from the center of the concentric circles. Black (light-blocking areas) and white (light-transmissive areas) are alternately arranged. Black (light-blocking areas) and white (light-transmissive areas) are alternately arranged in terms of the concentric circles in which the radius increases by a predetermined length. Regarding overlapping areas of areas formed by the radial lines or areas formed by the concentric circles, when one of the areas is white, the overlapping areas becomes white. The width of white areas extending in radial lines is constant from the inner periphery to the outer periphery. Another complex pattern of radial lines and concentric circles (not shown) may be a reversal pattern of the above-described complex pattern of radial lines and concentric circles, in which black portions and white portions are reversed.

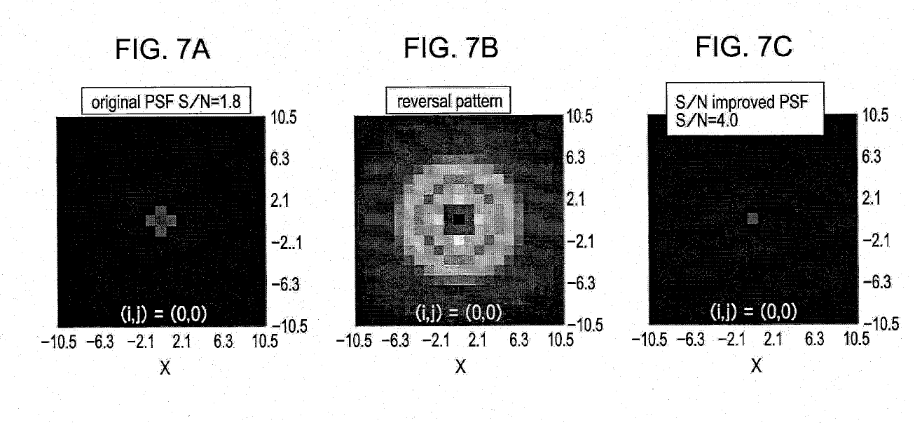

FIG. 7A shows a reconstructed image formed by diffracted light on the imaging surface of the array optical detector 21 in the case that, using the complex pattern of radial lines and concentric circles shown in FIGS. 6A and 6B as a reference light pattern, only the signal light pixel (0, 0), that is, the pixel at the center of the concentric circles serving as the center of the signal light area, is made to allow passage of a light beam to form a hologram in a holographic recording medium, and reference light from the complex pattern of radial lines and concentric circles, which is used at the time of recording, is emitted to the hologram. A dark portion is a portion where the light intensity is high (luminance is high). The center with the highest light intensity corresponds to a desired reconstructed signal, and neighboring areas distributed with continuous light intensities around the center correspond to degenerate noise components.

FIG. 7B shows a reconstructed image formed by diffracted light on the imaging surface of the array optical detector 21 in the case that, using a reversal pattern of the complex pattern of radial lines and concentric circles, which is used at the time of recording, reversal reference light is emitted to the same hologram.

FIG. 7C shows the result of calculating the difference (value of after-calculation reconstruction data ΔDᵢ) between a value of reconstruction data D₁ᵢ, which is a reconstructed signal based on the reference light pattern on the imaging surface of the array optical detector 21, and a value of reversal reconstruction data D₂ᵢ, which is a reconstructed signal based on the reversal pattern. As a result of calculating the difference, the S/N ratio of the reconstructed signal is improved from 1.8 (before the calculation) to 4.0 (after the calculation), which shows improvement in the signal quality.

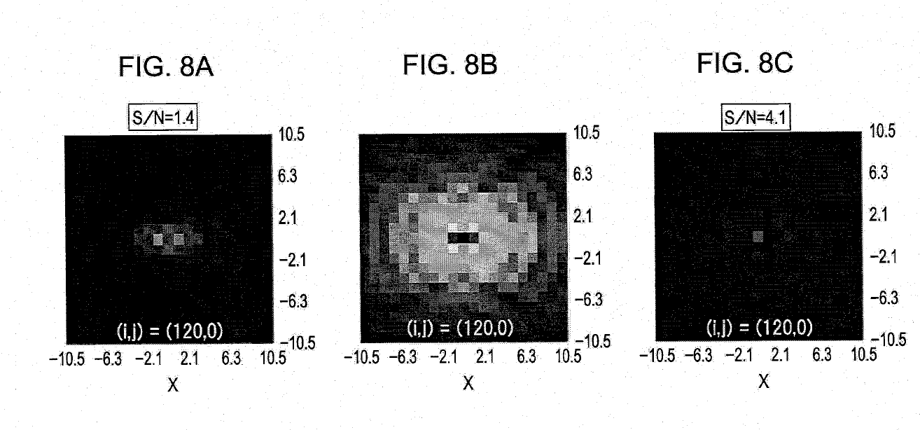

FIG. 8A shows a reconstructed image formed by diffracted light on the imaging surface of the array optical detector 21 in the case that, using the complex pattern of radial lines and concentric circles as a reference light pattern, only the signal light pixel (120, 0) is made to allow passage of a light beam to form a hologram in a holographic recording medium, and reference light from the complex pattern of radial lines and concentric circles, which is used at the time of recording, is emitted to the hologram.

FIG. 8B shows a reconstructed image formed by diffracted light on the imaging surface of the array optical detector 21 in the case that, using a reversal pattern of the complex pattern of radial lines and concentric circles, which is used at the time of recording, reversal reference light is emitted to the same hologram.

FIG. 8C shows the result of calculating the difference (value of after-calculation reconstruction data ΔDᵢ) between a value of reconstruction data D₁ᵢ, which is a reconstructed signal based on the reference light pattern on the imaging surface of the array optical detector 21, and a value of reversal reconstruction data D₂ᵢ, which is a reconstructed signal based on the reversal pattern. Also in this case, as is clear from FIG. 8C, the S/N ratio of the reconstructed signal is improved from 1.4 (before the calculation) to 4.1 (after the calculation).

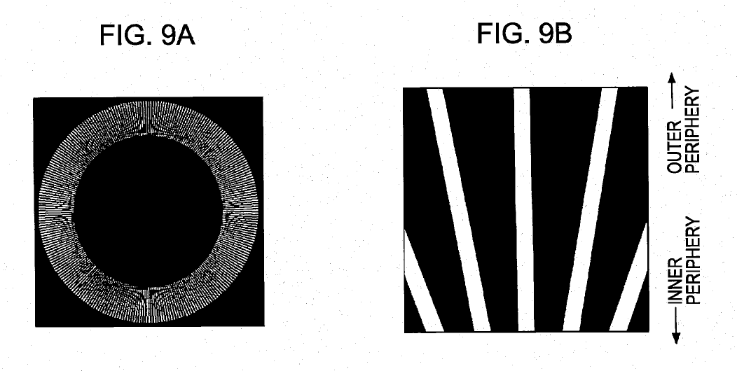

Further, the result of the case in which a radial pattern shown in FIGS. 9A and 9B is used as a reference light pattern is described now. FIG. 9A shows the entire pattern, and FIG. 9B shows an enlarged portion of the pattern. Here, the radial pattern is a pattern in which individual areas are segmented by radial lines that are adjacent with one another at predetermined angles and that extend from the center of the concentric circles. In the radial pattern, black portions and white portions are alternately arranged along line segments. The width of white portions is constant from the inner periphery through the outer periphery. In order to enable the single spatial light modulator 13 to display the reference light patterns shown in FIGS. 3A, 3B, 6A, 6B, 9A, and 9B, the pixels have a fixed shape, such as a square shape, as shown in FIG. 3B, and various reference light patterns can be displayed by stepwise approximation of radial line segments or concentric line segments.

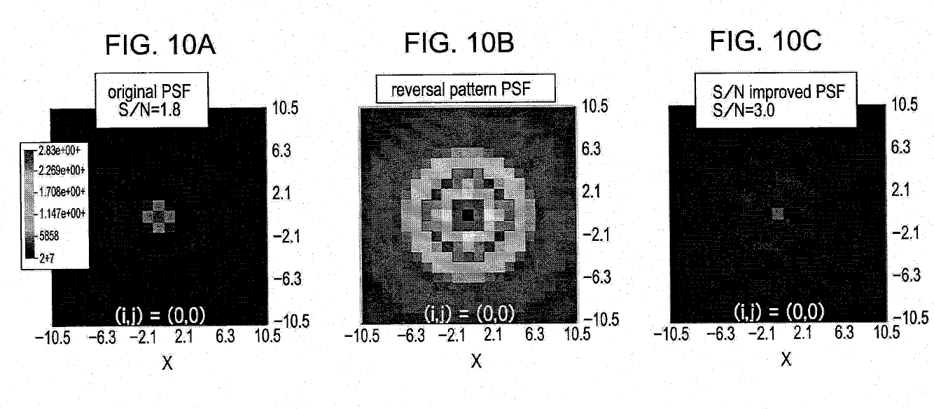

FIG. 10A shows a reconstructed image formed by diffracted light on the imaging surface of the array optical detector 21 in the case that, using the radial pattern shown in FIGS. 9A and 9B as a reference light pattern, only the signal light pixel (0, 0), which is the pixel at the center of the concentric circles serving as the center of the signal light area, is made to allow passage of a light beam to form a hologram in a holographic recording medium, and reference light from the radial pattern used at the time of recording is emitted to the hologram. A dark portion is a portion where the light intensity is high (luminance is high). The center with the highest light intensity corresponds to a desired reconstructed signal, and neighboring areas distributed with continuous light intensities around the center correspond to degenerate noise components.

FIG. 10B shows a reconstructed image formed by diffracted light on the imaging surface of the array optical detector 21 in the case that, using a reversal pattern of the radial pattern used at the time of recording, reversal reference light from the reversal pattern is emitted to the same hologram.

FIG. 10C shows the result of calculating the difference (value of after-calculation reconstruction data ΔDᵢ) between a value of reconstruction data D₁ᵢ, which is a reconstructed signal based on the reference light pattern on the imaging surface of the array optical detector 21, and a value of reversal reconstruction data D₂ᵢ, which is a reconstructed signal based on the reversal pattern. As a result of calculating the difference, the S/N ratio of the reconstructed signal is improved from 1.8 (before the calculation) to 3.0 (after the calculation), which shows improvement in the signal quality.

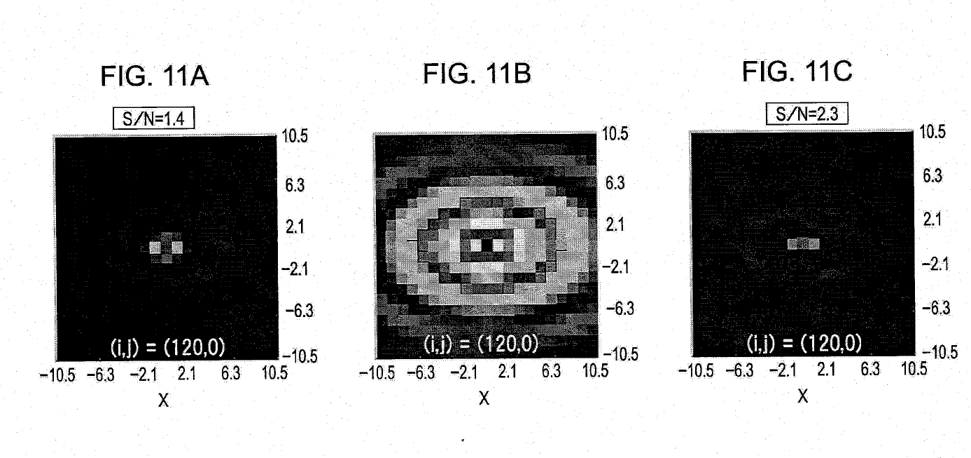

FIG. 11A shows a reconstructed image formed by diffracted light on the imaging surface of the array optical detector 21 in the case that, using the radial pattern as a reference light pattern, only the signal light pixel (120, 0) is made to allow passage of a light beam to form a hologram in a holographic recording medium, and reference light from the radial pattern used at the time of recording is emitted to the hologram.

FIG. 11B shows a reconstructed image formed by diffracted light on the imaging surface of the array optical detector 21 in the case that, using a reversal pattern of the radial pattern used at the time of recording, reversal reference light from the reversal pattern is emitted to the same hologram.

FIG. 11C shows the result of calculating the difference (value of after-calculation reconstruction data ΔDᵢ) between a value of reconstruction data D₁ᵢ, which is a reconstructed signal based on the reference light pattern on the imaging surface of the array optical detector 21, and a value of reversal reconstruction data D₂ᵢ, which is a reconstructed signal based on the reversal pattern. Also in this case, as is clear from FIG. 11C, the S/N ratio of the reconstructed signal is improved from 1.4 (before the calculation) to 2.3 (after the calculation).

Although the above description concerns the case in which the random pattern, the complex pattern of radial lines and concentric circles, or the radial pattern is used as a reference light pattern, other reference light patterns may also achieve the advantage of reducing the degenerate noise. Although the coaxial method in which the signal light pattern and the reference light pattern are completely separated into two areas has been described above by changing the reference light pattern to various patterns, the embodiment can be implemented in other various ways. For example, even in the coaxial method, the signal light pattern and the reference light pattern may be divided into arbitrary areas in a cross section of the optical beam.

Not only the calculation result (value of after-calculation reconstruction data ΔDᵢ) is obtained from the difference between the value of the reconstruction data D₁ᵢ, which is the reconstructed signal based on the reference light pattern, and the value of the reversal reconstruction data D₂ᵢ, which is the reconstructed signal based on the reversal pattern, but also the following may be possible. That is, one of the reconstruction data D₁ᵢ and the reversal reconstruction data D₂ᵢ may be multiplied by a predetermined coefficient k to yield new reconstruction data Dₖ₁ᵢ or new reversal reconstruction data Dₖ₂ᵢ, and the difference between the reconstruction data Dₖ₁ᵢ and the reversal reconstruction data D₂ᵢ or the difference between the reconstruction data D₁ᵢ and the reconstruction data Dₖ₂ᵢ may be obtained, thereby generating the after-calculation reconstruction data ΔDᵢ. Although the above description concerns the case in which the transmissive pixel of the signal pattern includes only the signal light pixel (0, 0) or the signal light pixel (120, 0), the same advantage of improving the S/N ratio of the reconstructed signal can be achieved by performing the above calculation for all the pixels in the case that any combination of all the signal light pixels serves as transmissive pixels.

Specific Recording and Reconstruction Processes

Referring back to FIG. 1, specific recording and reconstruction processes are described in more detail now. First, the recording process will be described. The controller 22 controls the laser light source 11 to emit a light beam with intensity suitable for recording. The controller 22 displays a signal light pattern on the basis of one page of data to be recorded (recording data) on the spatial light modulator 13 and a predetermined reference light pattern for a predetermined optimal period, which is set such that a hologram with excellent recording/reconstruction quality can be formed. Accordingly, a hologram is formed in the holographic recording medium 19. The reference light pattern in this case is, for example, the random pattern, the complex pattern of radial lines and concentric circles, or the radial pattern, which have been described above.

Next, the reconstruction process will now be described. The controller 22 controls the laser light source 11 to emit a light beam with intensity suitable for reconstruction. The controller 22 displays the same reference light pattern as that used at the time of recording on the spatial light modulator 13. In this case, the reference light pattern is stored in advance in a predetermined storage area of a random access memory (RAM) of the controller 22. Accordingly, diffracted light is generated, thereby displaying a reconstructed image on the array optical detector 21 via the condensing lens 20. An electric signal according to the luminance of the reconstructed image at each of the pixels of the array optical detector 21 is scanned in a time-series manner, detected as reconstruction data D₁ᵢ by the A/D converter, and stored in a first predetermined storage area of the RAM of the controller 22.

Next, the controller 22 displays a reversal pattern of the same reference light pattern as that used at the time of recording on the spatial light modulator 13. In this case, as is the case with the reference light pattern, the reversal pattern is also stored in advance in a predetermined storage area of the RAM of the controller 22. By emitting reference light passing through the reversal pattern onto the holographic recording medium 19, diffracted light is generated, thereby displaying a reconstructed image on the array optical detector 21 via the condensing lens 20. Reversal reconstruction data D₂ᵢ according to the luminance of the reconstructed image at each of the pixels arranged in two dimensions of the array optical detector 21 is scanned as one-dimensional time-series data, detected by the A/D converter, and stored in a second predetermined storage area provided in the controller 22.

In the first predetermined storage area and the second predetermined storage area, a storage area is reserved for each pixel of the array optical detector 21, and a piece of storage data is stored in that storage area. Therefore, the controller 22 reads the reconstruction data D₁ᵢ from the first predetermined storage area and the reversal reconstruction data D₂ᵢ from the second predetermined storage area, which correspond to the same pixel, multiplies the reconstruction data D₁ᵢ in the first predetermined storage area by the predetermined coefficient k to yield the new reconstruction data Dₖ₁ᵢ, subtracts the reversal reconstruction data D₂ᵢ from the new reconstruction data Dₖ₁ᵢ to obtain the after-calculation reconstruction data ΔDᵢ. Here, the value of the predetermined coefficient k is a positive real number set in advance by experiment such that a maximum S/N ratio can be obtained. Alternatively, instead of subtracting the reversal reconstruction data D₂ᵢ from the new reconstruction data Dₖ₁ᵢ, which is obtained by multiplying the reconstruction data D₁ᵢ in the first predetermined storage area by the predetermined coefficient k, the reversal reconstruction data D₂ᵢ may be multiplied by the predetermined coefficient k to yield the new reversal reconstruction data Dₖ₂ᵢ, and the new reversal reconstruction data Dₖ₂ᵢ may be subtracted from the reconstruction data D₁ᵢ in the first predetermined storage area to obtain the after-calculation reconstruction data ΔDᵢ.

Accordingly, the controller 22 calculates the after-calculation reconstruction data ΔDᵢ, which is difference data corresponding to each of the pixels. Error correction is applied on the after-calculation reconstruction data ΔDᵢ in predetermined sections, whereby the recorded data is reconstructed. Even in the case that the value of the predetermined coefficient is one, that is, the data is not multiplied by the predetermined coefficient k, a sufficient advantage of improving the S/N ratio can be achieved. Recording data that may not be reconstructed only using the reconstruction data D₁ᵢ can be reconstructed using the after-calculation reconstruction data ΔDᵢ. A more satisfactory reconstruction quality can be achieved by multiplying the reconstruction data by the predetermined coefficient k other than one.

Even in the case of recording data that may not be reconstructed using the after-calculation reconstruction data ΔDᵢ obtained simply by subtracting the reversal reconstruction data D₂ᵢ from the reconstruction data D₁ᵢ, a more satisfactory reconstruction quality can be achieved by using the after-calculation reconstruction data ΔDᵢ obtained by multiplying the reconstruction data by the predetermined coefficient k. A desired value of the predetermined coefficient k depends on the reference light pattern and the signal light pattern. Thus, further improvement of the S/N ratio can be achieved by setting in advance the value of the predetermined coefficient k according to the reference light pattern whose details are known in advance.

Alternatively, the value of the predetermined coefficient k may be changed as necessary in units of pages such that the bit error rate in the error correction processing can be minimized. More specifically, the same page is repeatedly reconstructed while sequentially changing the value of the predetermined coefficient k, and the value of the predetermined coefficient k with the smallest bit error rate is set as a fixed value. Using this fixed value, related pages can be reconstructed. Accordingly, a signal that may not be reconstructed without performing such processing to improve the S/N ratio can be reconstructed in a highly satisfactory manner without errors.

As has been described above, the most satisfactory S/N ratio can be achieved in the case that the random pattern shown in FIGS. 3A and 3B is used. Even in the case that the complex pattern of radial lines and concentric circles shown in FIGS. 6A and 6B or the radial pattern shown in FIGS. 9A and 9B is adopted, the S/N ratio is improved. Regarding a white rate (greater than or equal to zero and less than or equal to one), which is a value obtained by dividing the number of transmissive pixels allowing passage of a light beam by the total number of the pixels, the following knowledge is obtained by a numerical analysis. In the case that any one of the reference light pattern, the complex pattern of radial lines and concentric circles, and the radial pattern is adopted, satisfactory improvement of the S/N ratio can be achieved in which the white rate is within a range from 0.15 to 0.85. That is, in the case that the white rate of a reference light pattern is 0.15, the white rate of a corresponding reversal pattern is 0.85. In contrast, in the case that the white rate of a reference light pattern is 0.85, the white rate of a corresponding reversal pattern is 0.15. In the case that the white rate is within such a range, the difference between the white rate of the reference light pattern and the white rate of the reversal pattern is not significant, and hence satisfactory improvement of the S/N ratio can be achieved.

Although the above embodiment has been described using the coaxial method by way of example, this noise reducing technique is effective not only in the coaxial method, but also in the two-beam method. In a two-beam holographic optical system, however, a black mismatch noise component expressed as equation (2) and expression (3) is generated. That is, a condition for ΔP_{z}≠0 and η≠0 indicates that the reference light beam has an angular distribution relative to a plane formed by the signal light beam and the reference light beam. In other words, in the case of no angular distribution, ΔP_{z}=0 and η≠0. Hence, no degenerate noise component is generated, and the above-described noise removing technique becomes invalid.

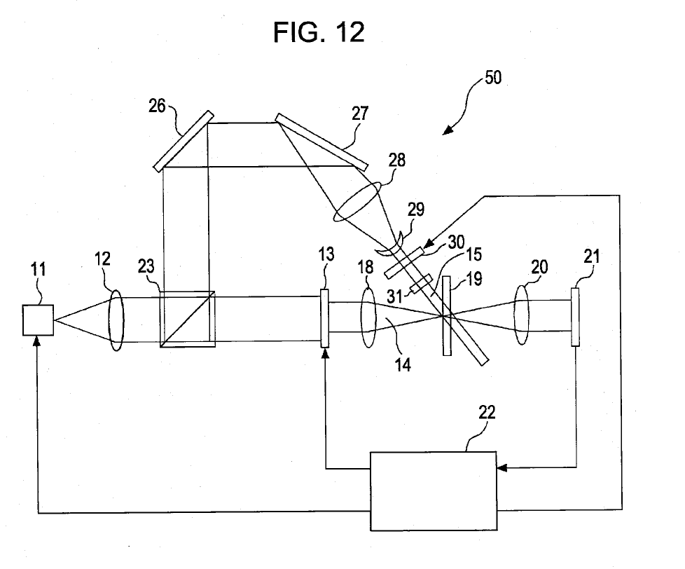

In order to satisfy the condition, it is necessary that the reference light beam be focused in a direction perpendicular to the plane formed by the signal light and the reference light. FIG. 12 shows a two-beam holographic recording/reconstruction apparatus 50 that satisfies the above condition. In FIG. 12, portions having the same structure and the same function as those in FIG. 1 are referred to using the same reference numerals.

In the holographic recording/reconstruction apparatus 50, a light beam emitted from the laser light source 11 passes through the collimating lens 12 and is split by a light beam splitter 23 into two light beams in two directions. The light beam in a straight direction enters the spatial light modulator 13. The spatial light modulator 13 modulates the light beam to generate an intensity-modulated light beam, which in turn is collected by the condensing lens 18 to generate signal light 14. In contrast, the optical beam reflected at right angle by the light beam splitter 23 is reflected by mirrors 26 and 27 and passes through a condensing lens 28 and a collimating lens 29, and the intensity of the optical beam is modulated by a spatial light modulator 30. The spatial light modulator 30 has substantially the same structure as that of the spatial light modulator 13. A cylindrical lens 31 collects the light beam in a direction perpendicular to the page to generate reference light 15. The signal light 14 and the reference light 15 are focused into the holographic recording medium 19 and intersect each other to form an interference pattern, whereby a hologram is formed. The above description concerns a signal recording procedure.

Next, a reconstruction procedure using the two-beam method is described. A light beam emitted from the laser light source 11 passes through the collimating lens 12 and the light beam splitter 23 and enters the spatial light modulator 13. In the case of reconstruction, the spatial light modulator 13 blocks the light beam in a signal optical path, whereby the light intensity becomes zero. In contrast, the light beam reflected at right angle by the light beam splitter 23 passes through the mirrors 26 and 27, the condensing lens 28, and the collimating lens 29, and then the intensity of the light beam is modulated by the spatial light modulator 30. The cylindrical lens 31 focuses the light beam as reference light 15 onto the hologram in the holographic recording medium 19. The reference light 15 diffracted from the hologram in the holographic recording medium 19 is collected by the condensing lens 20 to form a pattern having a light-intensity distribution, whereby an image is formed on the imaging surface of the array optical detector 21.

At the time of reconstruction, the reference light pattern of the spatial light modulator 30 is the same reference light pattern as that used at the time of recording. The reference light is emitted to the holographic recording medium 19 and collected by the condensing lens 20, whereby a reconstructed image is formed by diffracted light on the imaging surface of the array optical detector 21. On the basis of the reconstructed image, reconstruction data D₁ᵢ is generated and transferred into the controller 22. Then, using a reversal pattern of the reference light pattern of the spatial light modulator 30, reversal reference light is emitted to the holographic recording medium 19 and collected by the condensing lens 20, whereby a reconstructed image is formed by diffracted light on the imaging surface of the array optical detector 21. On the basis of the reconstructed image, reconstruction data D₂ᵢ is generated and transferred into the controller 22. In this manner, an advantage similar to the advantage of removing the degenerate noise in coaxial holography can also be achieved by the recording/reconstruction apparatus using the two-beam method.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A holographic reconstruction apparatus for reconstructing recording data recorded on a holographic recording medium from diffracted light generated by emitting reference light from a laser light source to the holographic recording medium, said holographic reconstruction apparatus comprising:
a spatial light modulator configured to apply spatial modulation on a light beam emitted from the laser light source to form a predetermined reference light pattern for generating the reference light;
an array optical detector configured to detect the luminance of a reconstructed image generated by the diffracted light and generate reconstruction data on the basis of the detected luminance; and
a controller configured to control the spatial light modulator to form, as the predetermined reference light pattern, a first reference light pattern and a second reference light pattern, the second reference light pattern being a reversal pattern of the first reference light pattern, and to reconstruct the recording data on the basis of a value of after-calculation reconstruction data according to a difference between a value of first reconstruction data based on the first reference light pattern and a value of second reconstruction data based on the second reference light pattern, the first and second reconstruction data coming from the array optical detector.

2. The holographic reconstruction apparatus according to claim 1, wherein the first reference light pattern is a pattern in which pixels are arranged at random, each of the pixels allowing passage of or blocking the light beam, and the fraction of the number of transmissive pixels allowing passage of the light beam to the total number of pixels ranges from 0.15 to 0.85.

3. The holographic reconstruction apparatus according to claim 1, wherein the first reference light pattern is a pattern in which pixels are arranged in radially extending lines, each of the pixels allowing passage of or blocking the light beam, and the fraction of the number of transmissive pixels allowing passage of the light beam to the total number of pixels ranges from 0.15 to 0.85.

4. The holographic reconstruction apparatus according to claim 1, wherein the first reference light pattern is a pattern in which pixels are enclosed by radial lines and concentric circles, each of the pixels allowing passage of or blocking the light beam, transmissive areas and light-blocking areas are alternately arranged along line segments so as to be adjacent to each other, and the fraction of the number of transmissive pixels allowing passage of the light beam to the total number of pixels ranges from 0.15 to 0.85.

5. The holographic reconstruction apparatus according to claim 1, wherein the controller multiplies the value of the first reconstruction data or the value of the second reconstruction data by a predetermined coefficient to obtain the after-calculation reconstruction data.

6. A holographic recording/reconstruction apparatus for recording, as a hologram, an interference pattern generated by emitting reference light and signal light from a laser light source onto a holographic recording medium and reconstructing recording data recorded on the holographic recording medium from diffracted light obtained by emitting the reference light to the holographic recording medium in which the hologram is recorded, said holographic recording/reconstruction apparatus comprising:
a spatial light modulator configured to apply spatial modulation on a light beam emitted from the laser light source to form a predetermined reference light pattern for generating the reference light and a signal light pattern according to the recording data on the same plane;
an array optical detector configured to detect the luminance of a reconstructed image generated by the diffracted light and generate reconstruction data on the basis of the detected luminance; and
a controller configured to control the spatial light modulator to form, as the predetermined reference light pattern, a first reference light pattern and a second reference light pattern, the second reference light pattern being a reversal pattern of the first reference light pattern, and to reconstruct the recording data on the basis of after-calculation reconstruction data, which is a difference between first reconstruction data based on the first reference light pattern and second reconstruction data based on the second reference light pattern, the first and second reconstruction data coming from the array optical detector.

7. A holographic reconstruction method of reconstructing recording data recorded on a holographic recording medium from diffracted light generated by emitting reference light from a laser light source to the holographic recording medium, comprising:
applying spatial modulation on a light beam emitted from the laser light source to generate first reference light;
applying spatial modulation on the light beam emitted from the laser light source to generate second reference light, the second reference light being reversal reference light of the first reference light;
detecting first reconstruction data from diffracted light obtained by emitting the first reference light;
detecting second reconstruction data from diffracted light obtained by emitting the second reference light; and
reconstructing the recording data on the basis of a value of after-calculation reconstruction data according to a difference between a value of the first reconstruction data and a value of the second reconstruction data.
